(19) United States
(12) Patent Application Publication
(10) Pub. No.: US 2021/0026774 A1
(43) Pub. Date: Jan. 28, 2021

(54) DATA PROCESSING SYSTEM AND OPERATING METHOD THEREOF

(71) Applicant: SK hynix Inc., Icheon (KR)

(72) Inventor: Min Soo LIM, Hwaseong (KR)

(21) Appl. No.: 16/802,387

(22) Filed: Feb. 26, 2020

(30) Foreign Application Priority Data
Jul. 26, 2019 (KR) 10-2019-0090722

(51) Int. Cl. G06F 12/0882; G06F 12/02; G06F 9/30; G06F 13/16

(52) U.S. Cl. CPC G06F 12/0882; G06F 12/0246; G06F 13/1668; G06F 9/30101; G06F 9/30189

(57) ABSTRACT

A data processing system may include a memory apparatus and a controller configured to control the memory apparatus. The memory apparatus includes a plurality of pages and is accessible in units of the pages. The controller may include a mode control component configured to generate an activation mode control signal for setting the memory apparatus in a partial page activation mode based on a type of a processing task requested by a host and address information requested to be accessed, and wherein less than all of a page of the memory apparatus being accessed is activated when the memory apparatus is in the partial page activation mode.

### CROSS-REFERENCES TO RELATED APPLICATION

The present application claims priority under 35 U.S.C. § 119(a) to Korean application number 10-2019-0090722, filed on Jul. 26, 2019, in the Korean Intellectual Property Office, which is incorporated herein by reference in its entirety.

### BACKGROUND

### 1. Technical Field

Various embodiments generally relate to a computing device, and more particularly, to a data processing system and an operating method thereof.

### 2. Related Art

With an increase in interest and importance for artificial intelligence applications and big data analytics, there are increasing demands for a computing system capable of efficiently processing large amounts of data.

While traditional computing systems have focused on process-centric computing, recent computing systems have evolved into data-centric computing or memory-centric computing capable of processing enormous data in parallel at a high speed. This can reduce data bottlenecks between a processor and a memory, resulting in the maximization of computational performance.

However, improving the performance and speed of the computing device may lead to an increase in energy consumption.

### SUMMARY

In an embodiment, a data processing system may include a memory apparatus including a plurality of pages and accessible in units of the pages; and a controller configured to control the memory apparatus, wherein the controller comprises: a mode control component configured to generate an activation mode control signal for setting the memory apparatus in a partial page activation mode based on a type of a processing task requested by a host and address information requested to be accessed, and wherein less than all of a page of the memory apparatus being accessed is activated when the memory apparatus is in the partial page activation mode.

In an embodiment, a data processing system may include: a memory apparatus including a plurality of pages and accessible in units of the pages; and a controller configured to control the memory apparatus, wherein the controller comprises: a mode control component configured to control, in response to a request of a host for processing an application offloaded and requested to be processed by the host and address information requested to be accessed, the memory apparatus to activate only a sub-page of a page of the memory apparatus being accessed; and an accelerator configured to process the application according to data read from the activated sub-page so as to execute the application and to store a processing result in the activated sub-page.

In an embodiment, an operating method a data processing system including a memory apparatus including a plurality of pages and accessible in units of the pages and a controller configured to control the memory apparatus, may include: transmitting, by the controller and to the memory apparatus, an activation mode control signal for activating a partial page activation mode of the memory apparatus based on a type of a processing task requested by a host and address information requested to be accessed; and activating, by the memory apparatus, only a sub-page of a page of the memory apparatus being accessed when the memory apparatus is in the partial page activation mode.

### BRIEF DESCRIPTION OF THE DRAWINGS

FIG. 1 illustrates an electronic apparatus including a data processing system in accordance with an embodiment.

FIG. 2 illustrates a memory apparatus in accordance with an embodiment.

FIG. 3 illustrates a controller in accordance with an embodiment.

FIG. 4 illustrates a process for operating a data processing system in accordance with an embodiment.

FIG. 5 and FIG. 6 illustrates a mode setting process in accordance with an embodiment.

FIG. 7 illustrates a process for operating a data processing system in accordance with another embodiment.

FIG. 8 and FIG. 9 illustrate a mode setting process in accordance with another embodiment.

FIGS. 10, 11, and 12 illustrate stacked semiconductor apparatuses in accordance with embodiments.

FIG. 13 illustrates a network system including a data storage device in accordance with an embodiment.

### DETAILED DESCRIPTION

Hereinafter, a data processing system and an operating method thereof will be described in more detail below with reference to the accompanying drawings.

FIG. 1 is a configuration diagram of an electronic apparatus 1 including a data processing system 100 in accordance with an embodiment.

The electronic apparatus 1 may include a host 10 and the data processing system 100.

The electronic apparatus 1 may be one of various electronic apparatuses such as a personal computer, a server computer, a mobile computing device, and an electronic control device of a vehicle.

The electronic apparatus 1 may include a high performance computing (HPC) device that performs computations in a cooperative manner by using a super computer or a computer cluster, or an array of networked information processing devices or servers that process data individually.

The host 10 may provide a user with various services through a user interface. To this end, the host 10 may transmit requests and addresses related to data processing, and data, if necessary, to the data processing system 100, and receive processing results therefrom.

The data processing system 100 may perform corresponding operations in response to the requests and addresses of the host 10, and transmit data to the host 10, if necessary.

The host 10 may request the data processing system 100 to perform data input/output, or may offload processing for an application involving data input/output to the data processing system 100 and request that the data processing system 100 to perform the application. At the time of offloading the processing for the application and requesting the application be performed, the host 10 may transmit operation control information and an initial parameter to the data processing system 100. The operation control information may include the type of an application to be performed by the data processing system 100, a program code storage address of the application, an input data storage address, and an initial parameter storage address. The initial parameter may include, using a neural network application as an example, input data and an initial weight.

The data processing system 100 may process the requests of the host 10 in response to the operation control information and the initial parameter. Offloading means entrusting a computation of the host 10 to another device, for example, the data processing system 100.

In an embodiment, the host 10 may offload a neural network application, that is, a computation used for neural network processing, to the data processing system 100 and request that the data processing system 100 perform the application; however, embodiments are not limited thereto.

The data processing system 100 may include a memory apparatus 200 and a controller 300.

In order to offload processing of a specific application to the data processing system 100 and request the data processing system 100 to process the specific application, the host 10 may transmit the operation control information to the controller 300 and transmit the initial parameter to the memory apparatus 200 for storage.

The memory apparatus 200 may store data and/or output the stored data under the control of the controller 300. The memory apparatus 200 may include a plurality of memory modules 200-1 to 200-l and may be configured to be accessible in units of pages. That is, the controller 300 may access the memory apparatus 200 in units of pages.

The memory modules 200-1 to 200-l may include volatile memory modules and/or nonvolatile memory modules. A memory module may include a plurality of memory cells connected between a word line (row line) and a bit line (column line, string), and in embodiments, the memory cells connected to one word line may constitute one page.

A volatile memory module may include a dynamic random access memory (DRAM) and/or a static random access memory (SRAM), for example. A nonvolatile memory module may include at least one of an electrically erasable and programmable ROM (EEPROM), a NAND flash memory, a NOR flash memory, a phase-change RAM (PRAM), a resistive RAM (ReRAM), a ferroelectric RAM (FRAM), and a spin torque transfer magnetic RAM (STT-MRAM), for example.

In an embodiment, each of the memory modules 200-1 to 200-l may be in the form of a single in-line memory module (SIMM) or a dual in-line memory module (DIMM) including a plurality of memory chips mounted on a module board, or in the form of a high bandwidth memory (HBM) module. The HBM module may include a plurality of HBMs and at least one hardware accelerator mounted on an interposer. In an embodiment, the memory modules 200-1 to 200-l may be configured to include the controller 300 on the module board or to include the controller 300 on a base die in the case of the HBM module.

The controller 300 may read a program code from a memory area corresponding to the application program code storage address of the operation control information provided from the host 10, load the application program code into an internal memory, read the initial parameter from the memory apparatus 200, load the initial parameter into the internal memory, and execute the application program code to perform a computation using the initial parameter. The application program code may be stored in the memory of the host 10 or the nonvolatile memory module of the memory apparatus 200. Data generated as the application program code is executed may be stored in the memory apparatus 200. For example, data generated by executing the program code may be temporarily stored in the volatile memory module, and then may be stored in the nonvolatile memory module, if necessary.

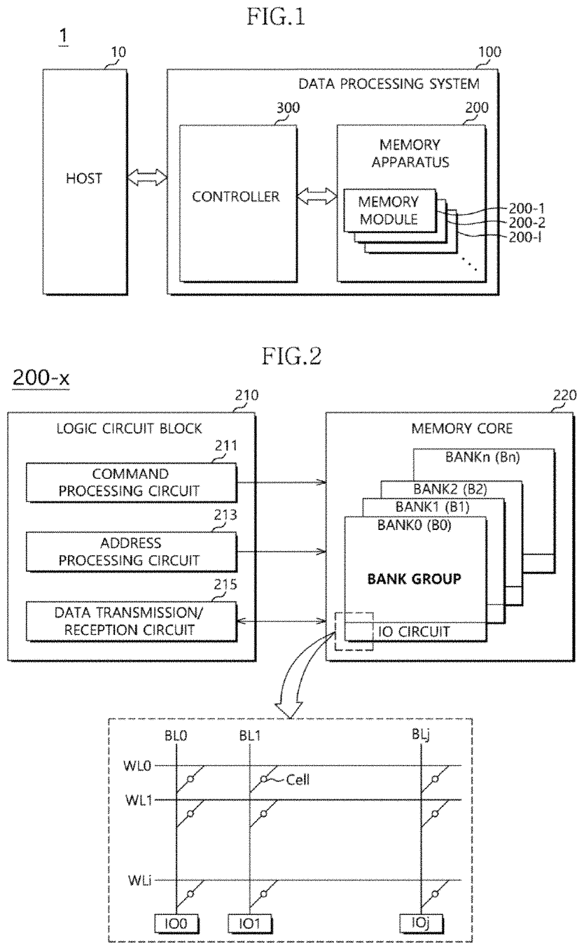

In an embodiment, the host 10 may offload machine learning or artificial intelligence applications, for example, neural network computations, to the data processing system 100 and request the data processing system 100 to process the neural network computations. The storage position of data used during the processing of the neural network computations, for example, input data and parameters, such as weights, may be fixed to a partial area of a page in the memory apparatus 200. That is, during the neural network computation processing, the controller 300 may have a characteristic of sequentially accessing only a partial area of the pages included in the memory modules 200-1 to 200-l in the memory apparatus 200. For example, the memory module may be a DRAM and the controller 300 may have a pattern of sequentially accessing memory cells in a sub-page such as a selected quarter or a selected one-eighth of the memory cells in each successive selected page in the DRAM during the neural network computation processing. That is, referring to the memory array shown FIG. 2, in an embodiment a computation may access only cells connected to one of bit lines BLx to BLy in a sequence of word lines WLa, Wlb, WLc, . . . , where x and y are in 0 to j, the bit lines BLx to BLy are a fraction less than 1 (such as one-quarter or one-eighth) of the all the bit lines connected to each word line, and a, b, c, . . . are in 0 . . . i.

In an embodiment, when the host 10 requests performance of a neural network computation processing task, the controller 300 may generate an activation mode control signal for activating a partial page activation mode of the memory apparatus 200 to be accessed and in response to the activation mode control signal, the page of the memory apparatus 200 may be partially activated as described herein.

In another aspect, the controller 300 may include an accelerator that processes a specific application offloaded according to a request of the host 10, and the accelerator may partially activate a page of the memory apparatus 200 to be accessed in response to an application processing request.

In summary, when a computation offloaded by the host 10 and performed by the data processing system 100, is a computation that inputs and/or outputs data by repeatedly accessing only a sub-page, which is a partial area of a page (for example, when the computation is a neural network computation), only the sub-page repeatedly accessed among the pages constituting the data processing system 100 is activated, which may reduce power consumption compared with a case where all memory cells of a page to be accessed are activated.

FIG. 2 is a configuration diagram of the memory apparatus 200 in accordance with an embodiment. The memory apparatus 200 may be included in one or more of the memory modules 200-1 to 200-l of FIG. 1.

The memory apparatus 200 may include a logic circuit block 210 and a memory core 220.

The logic circuit block 210 may include a command processing circuit 211, an address processing circuit 213, and a data transmission/reception circuit 215.

The command processing circuit 211 may buffer and decode a command provided from the controller 300, and provide the decoded command to the memory core 220.

The address processing circuit 213 may buffer and decode an address provided from the controller 300, and provide the decoded address to the memory core 220.

The data transmission/reception circuit 215 may be configured to transfer data provided from the controller 300 to the memory core 220, and transfer data provided from the memory core 220 to the controller 300.

The memory core 220 may include a plurality of banks B0 to Bn. Each of the banks B0 to Bn may include a plurality of word lines WL0 to WLi (corresponding to rows and to pages), a plurality of bit lines BL0 to BLj (corresponding to columns and to strings), a plurality of memory cells connected between the word lines and the bit lines, and input/output circuits IO1 to IOj that are connected to the bit lines BL0 to BLj to write (input) data into the memory cells or read (output) data from the memory cells.

In an embodiment, the memory cell may be a DRAM cell; however, embodiments are not limited thereto.

The memory cell may be randomly accessible in units of pages. In order to request the data processing system 100 to process a specific application, for example, an application requiring a neural network computation, the host 10 may transmit operation control information for the neural network computation to the controller 300 and transmit an initial parameter used in the neural network computation to the memory apparatus 200.

Accordingly, the controller 300 may read the application program code from the memory area corresponding to the application program code storage address in the operation control information, and load the read application program code into an internal memory.

Meanwhile, the memory apparatus 200 may store the initial parameter transmitted from the host 10. To this end, the address processing circuit 213 of the memory apparatus 200 may decode an address included in the initial parameter provided from the controller 300 and activate a subset of memory cells connected to a page of the memory apparatus 200 to be accessed, and the data transmission/reception circuit 215 of the memory apparatus 200 may store the initial parameter in the activated memory cells.

During the neural network computation, the controller 300 reads the initial parameter from the memory apparatus 200 and performs computations using the initial parameter by executing the application program code, and the parameter changed as a result of the computation may be stored again in a corresponding position of the memory apparatus 200.

When data required for the neural network computation is inputted/outputted, memory cells may be activated in units of sub-pages such as ¼ or ⅛ of the page to be accessed, which may significantly reduce power consumption compared with a case where all memory cells connected to the page are activated to input and output data.

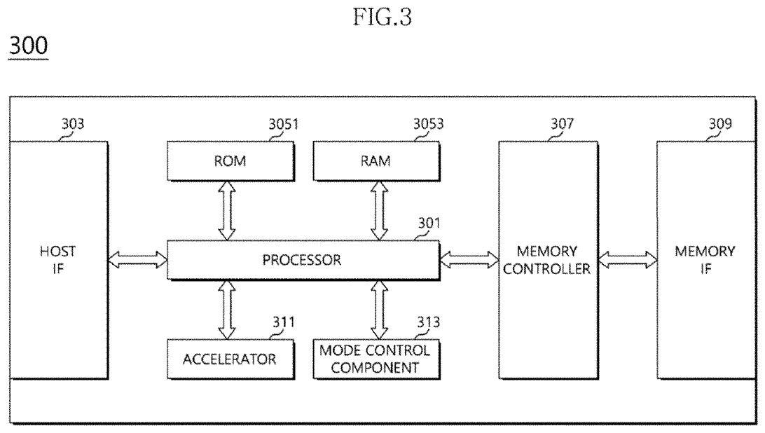

FIG. 3 is a configuration diagram of the controller 300 in accordance with an embodiment.

The controller 300 in may include a processor 301, a host interface (IF) 303, a ROM 3051, a RAM 3053, a memory controller 307, a memory IF 309, an accelerator 311, and a mode control component 313.

The processor 301 may control overall operations of the memory apparatus 200, and perform a computation requested by the host 10 in response to a command transmitted by the host 10. In order to perform the computation requested by the host 10, the processor 301 may use data provided from the host 10 and/or from the memory apparatus 200.

In an embodiment, the processor 301 may perform a computation for a specialized application that is executed in the electronic apparatus 1. In an embodiment, the electronic apparatus 1 may execute a machine learning application or an artificial intelligence application requiring a high bandwidth, and the processor 301 may execute a function specialized for the machine learning or artificial intelligence application.

The host IF 303 may provide an interface between the host 10 and the data processing system 100. The host IF 303 may store, decode, and schedule a command provided from the host 10 and provide the processed command to the processor 301. The host IF 303 may provide the processor 301 or the memory IF 309 with data provided from the host 10, or provide the host 10 with data provided from the memory apparatus 200 through the memory IF 309, under the control of the processor 301.

The memory IF 309 may transmit the data provided from the host IF 303 or the processor 301 to the memory apparatus 200, or receive data read from the memory apparatus 200 and provide the received data to the processor 301 or the host IF 303. To this end, the memory IF 309 may provide a communication channel for signal transmission/reception between the controller 300 and the memory apparatus 200. The memory IF 309 may provide a path through which the host 10 may directly access the memory apparatus 200 or access the memory apparatus 200 through the controller 300.

The ROM 3051 may store program codes required for the operation of the controller 300, for example, firmware or software, and store code data and the like used by the program codes.

The RAM 3053 may store data required for the operation of the controller 300 or data generated by the controller 300.

The host 10 may offload computational processing for a specific application to the data processing system 100 such that the accelerator 311 of the controller 300 performs the computational processing, and the processor 301 may extract and decode an offload command to control the accelerator 311.

The accelerator 311 may perform the computation according to an application program code, which is loaded into the RAM 3053, in response to a command from the processor 301. Data generated as a result of the computational processing of the accelerator 311 may be stored in a specific area of the memory apparatus 200 or may be transmitted to the host 10.

In an embodiment, the accelerator 311 may include an arithmetic logic unit (ALU) and a floating-point unit (FPU). The accelerator 311 may be selected from various types of accelerators such as a field-programmable gate array (FPGA), a massively parallel processor array (MPPA), a graphics processing unit (GPU), an application-specific integrated circuit (ASIC), a neural processing unit (NPU), a tensor processing unit (TPU), and a multi-processor system-on-chip (MPSoC). In an embodiment, an accelerator 311 may be provided for each of the memory modules 200-1 to 200-l; in another embodiment an accelerator 311 may be provided for the plurality of memory modules 200-1 to 200-l. The memory modules 200-1 to 200-l may input/output data in response to a command and an address from the accelerator 311.

Although not illustrated in the drawings, the accelerator 311 may include a command controller and a cache memory. In the case of the accelerator 311 for the neural network computation, computation target input data, weights, and a computation result may be stored in the cache memory. During the neural network computation processing, input data and weights stored in predetermined positions of the memory modules 200-1 to 200-l may be read, loaded into the accelerator 311, and subjected to a computation, and updated weights may be stored again in substantially the same positions of the memory modules 200-1 to 200-l and used for subsequent computations.

In an embodiment, in order to offload computational processing for a specific application to the data processing system 100, the host 10 may transmit operation control information including the type of an application of a computation to be offloaded and processed, a program code storage address of the application, and an initial parameter storage address, an initial parameter, and an storage address thereof.

The processor 301 may access the program code storage address, load and execute a program code into the RAM 3053, for example, to perform a computation, and store a result of the computation in the memory apparatus 200.

The mode control component 313 may receive the decoding result of the command of the host 10 from the processor 301. When the command of the host 10 is a request for a specific application to be executed by using the accelerator 311, the mode control component 313 may generate an activation mode control signal that enables a partial page activation mode of the memory apparatus 200.

In an embodiment, the host 10 may provide an initial parameter and a storage address thereof to the data processing system 100 when requesting the execution of an application involving a neural network computation. Accordingly, the mode control component 313 may generate an activation mode control signal including a sub-page address to be activated.

Although FIG. 3 illustrates the mode control component 313 separately from the processor 301, the mode control component 313 may be included in the processor 301, that is, the processor 301 may perform some or all of the functions of the mode control component 313 (for example, by executing mode control firmware).

The activation mode control signal is provided to the memory apparatus 200 through the memory controller 307, and in response the memory apparatus 200 may activate only a part of a page being accessed to input or output data.

The application offloaded to the data processing system 100 by the host 10 may be a machine learning application requiring a high bandwidth or an application specialized for big data processing. In order to write or read data used for the execution of such an application to/from the memory apparatus 200, memory cells of an entire page to be accessed are not activated but are activated in units of sub-pages, so that unnecessary power consumption may be avoided.

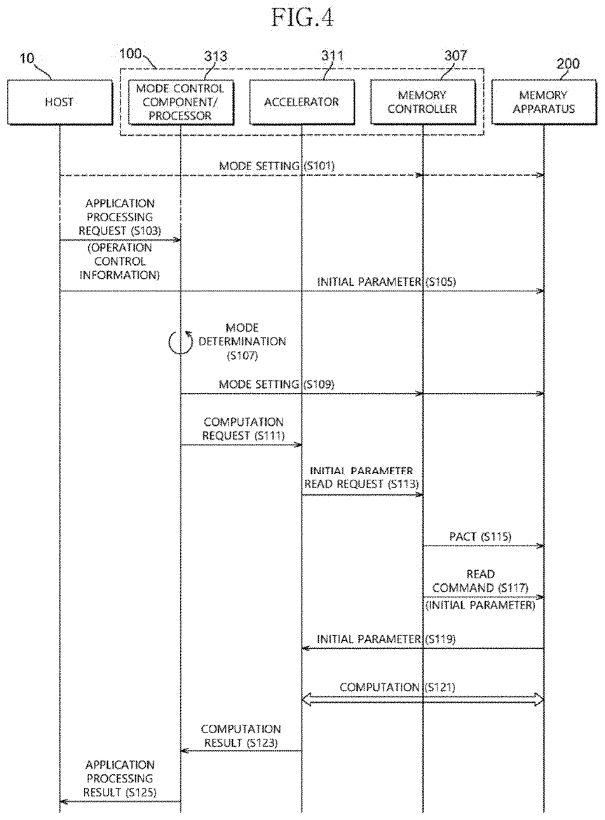

FIG. 4 is a sequence diagram for explaining operation of the data processing system in accordance with an embodiment.

In the embodiment of FIG. 4, in order to place the memory apparatus 200 in the partial page activation mode, the host 10 may set an activation mode of the memory apparatus 200 (S101) by providing, through the controller 300, the memory apparatus 200 with a mode setting command for enabling or disabling a partial page activation mode, and the memory apparatus 200 may set a mode register set (MRS) in response to the mode setting command.

The host 10 may transmit, to the data processing system 100, a command for offloading a specific application and requesting the data processing system 100 to perform the specific application (S103). In such a case, the host 10 may transmit, to the controller 300, operation control information including the type of the application, a program code storage address of the application, and an initial parameter storage address. Also, the host 10 may transmit the initial parameter and the storage address thereof to the memory apparatus 200 to write the initial parameter to the memory apparatus 200 (S105).

The application offloaded and requested to be performed may be any application. When, for example, the offloaded application is a neural network computation, and the initial parameter may include input data and an initial weight.

As the processor 301 decodes the command, the mode control component 313 may determine whether the command of the host 10 is a request to be executed by using the accelerator 311 and whether the command is a request that enables partial page activation (S107). The request of the host 10 may be a request for data input/output to/from the memory apparatus 200, and in such a case, the controller 300 may transfer data between the host 10 and the memory apparatus 200 without the intervention of the accelerator 311.

When the host 10 offloads processing for a specific application and requests the application be executed, and furthermore, when the partial page activation mode is enabled by the host 10 in step S101, the mode control component 313 may generate an activation mode control signal for partially activating a page to be accessed of the memory apparatus 200 and set an activation mode of the memory apparatus 200 based on the activation mode control signal (S109). In an embodiment, the mode control component 313 may enable the partial page activation mode by changing the mode register set (MRS) of the memory apparatus 200 through the memory controller 307.

If the host 10 has disabled the partial page activation mode in step S101, the mode control component 313 may not enable the partial page activation mode and the memory apparatus 200 may operate in a mode in which the memory cells of a page are all activated when that page is accessed. In such a case, when the memory apparatus 200 is accessed, the entire selected page is activated, so that it is possible to ensure a normal operation of the memory apparatus 200.

When the activation mode of the memory apparatus 200 is set, the processor 301 may request the accelerator 311 to execute program code of the corresponding application (S111).

In response to this, the accelerator 311 may request the memory controller 307 to read the initial parameter from the memory apparatus 200 (S113).

The memory controller 307 may transmit an activation mode control signal PACT to the memory apparatus 200 based on the initial parameter storage address included in the operation control information (S115).

In an embodiment, the activation mode control signal PACT may be transmitted using an operation control signal interface transmitted from the memory controller 307 to the memory apparatus 200 in, for example, an active command (ACT).

The active command (ACT) is a command transmitted from the memory controller 307 to the memory apparatus 200 in order to activate a specific memory bank among a plurality of memory banks included in the memory apparatus 200 configured as a DRAM. The active command (ACT) may be transmitted in two cycles of a clock on both the rising and falling edges of the clock, and among the interface signals used to transmit the active command (ACT), there are interface signals R[6] and R[7] that may have been unused in an active command (ACT) of the prior art.

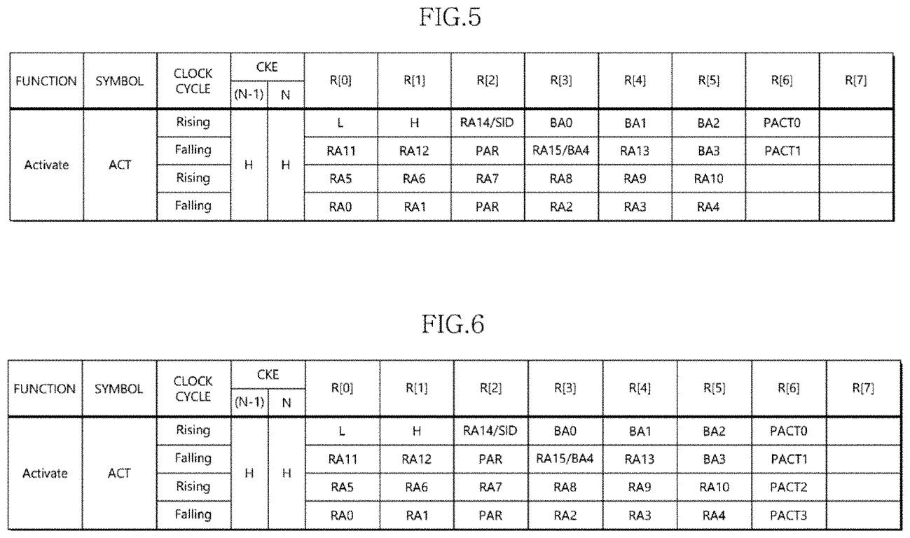

FIG. 5 and FIG. 6 are diagrams for explaining mode setting processes in accordance with embodiments, and show signals in an active command (ACT) according to embodiments.

Referring to FIG. 5 and FIG. 6, the position of a sub-page to be activated may be transmitted through the interface signal R[6].

FIG. 5 illustrates a case where an activation mode signal PACT includes 2-bit activation mode control signals PACT0 and PACT1 that are transmitted using the interface signal R[6] on the rising and falling edges of the first cycle of transmitting the active command ACT.

Accordingly, each page may be divided into four sub-pages using the 2-bit activation mode control signals PACT and may be partially activated on a sub-page basis, that is, one-quarter of a page at a time.

FIG. 6 illustrates a case where an activation mode signal PACT includes 4-bit activation mode control signals PACT0 to PACT3 that are transmitted using the interface signal R[6] on the rising and falling edges of the first and second cycles of transmitting the active command ACT. Accordingly, each page may be divided into 16 sub-pages using the 4-bit activation mode control signals PACT and may be partially activated on a sub-page basis, that is, one-sixteenth of a page at a time.

Although not illustrated, the interface signal R[7] may also be additionally used to transmit the activation mode control signals PACT. Accordingly, the page to be accessed may be divided into 2⁰ to 2⁸ sub-pages and may be partially activated on a sub-page basis.

Referring back to FIG. 4, when the page to be accessed is partially activated by the activation mode control signals PACT, the memory controller 307 may request the memory apparatus 200 to read data stored in the initial parameter storage address (S117), and the memory apparatus 200 may read the data stored in the corresponding address, that is, the initial parameter and provide the read initial parameter to the accelerator 311 (S119).

The accelerator 311 may load the initial parameter and process the computation (S121). Data may be inputted and outputted to/from the memory apparatus 200 partially activated during the computational processing.

When the computation is completed, the accelerator 311 may provide the computation result to the processor 301 (S123), and the processor 301 may provide the application processing result to the host 10 (S125).

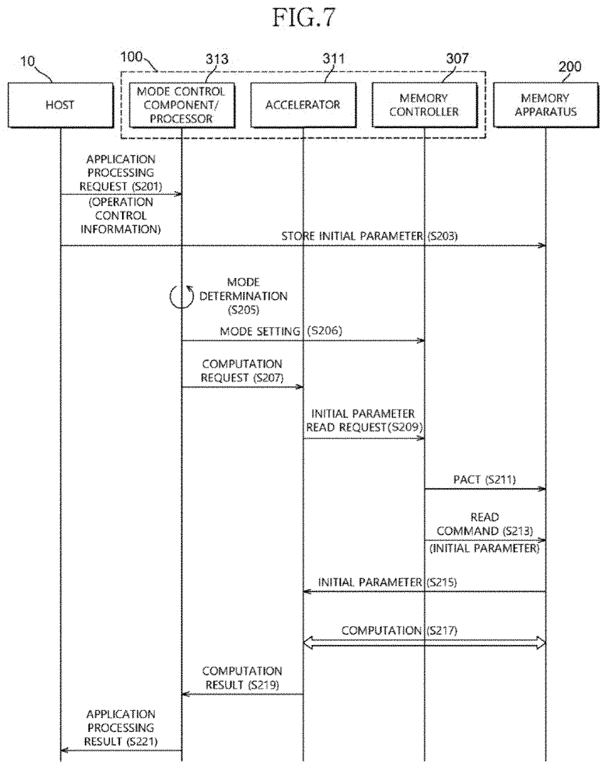

FIG. 7 is a sequence diagram for explaining operation of the data processing system in accordance with another embodiment. The embodiment of FIG. 7 differs from the embodiment of FIG. 4 in that the setting of the memory apparatus 200 into the partial page activation mode is performed using the activation mode control signal PACT in S211 of FIG. 7, instead of being performed by the setting of the activation mode in S101 of FIG. 4.

The host 10 may transmit, to the controller 300 of the data processing system 100, a command for offloading processing for a specific application and requesting that the specific application be performed (S201). In such a case, the host 10 may transmit, to the controller 300, operation control information including the type of the application to be processed, a program code storage address of the application, and an initial parameter storage address (S203). Also, the host 10 may transmit the initial parameter and the storage address thereof to the memory apparatus 200 to write the initial parameter into the memory apparatus 200 (S203).

The application offloaded and requested to be performed may be any application. For example, the application may include a neural network computation and the initial parameter may include input data and an initial weight.

As the processor 301 decodes the command, the mode control component 313 may determine whether the request of the host 10 is a request to be executed by using the accelerator 311, and also whether it is a request that enables partial page activation (S205). The request of the host 10 may be a request for data input/output to/from the memory apparatus 200, and in such a case, the controller 300 may transfer data between the host 10 and the memory apparatus 200 without the intervention of the accelerator 311. When the request of the host 10 is a request for offloading processing for the specific application, the mode control component 313 may send a mode setting information for generate an activation mode control signal PACT for potentially partially activating a page of the memory apparatus 200 to be accessed to the memory controller (S206), and the processor 301 may request the accelerator 311 to execute a program code of the application (S207).

In response to this, the accelerator 311 may request the memory controller 307 to read the initial parameter from the memory apparatus 200 (S209).

The memory controller 307 may transmit the activation mode control signal PACT generated using the mode setting information from the mode control component 313 to the memory apparatus 200 to set an activation mode of the memory apparatus 200 (S211). In an embodiment, the memory controller 307 may transmit the activation mode control signal PACT to the memory apparatus 200 based on the initial parameter storage address.

For example, the activation mode control signal PACT may be transmitted using a command interface transmitted from the memory controller 307 to the memory apparatus 200, for example, an active command (ACT).

The active command (ACT) is a command transmitted from the memory controller 307 to the memory apparatus 200 in order to activate a specific memory bank among a plurality of memory banks included in the memory apparatus 200 configured as a DRAM. The active command (ACT) may be transmitted in two cycles of a clock on the rising and falling edges of the clock, and among them, there are interface signals R[6] and R[7] that may have been unused in an activate command (ACT) of the prior art.

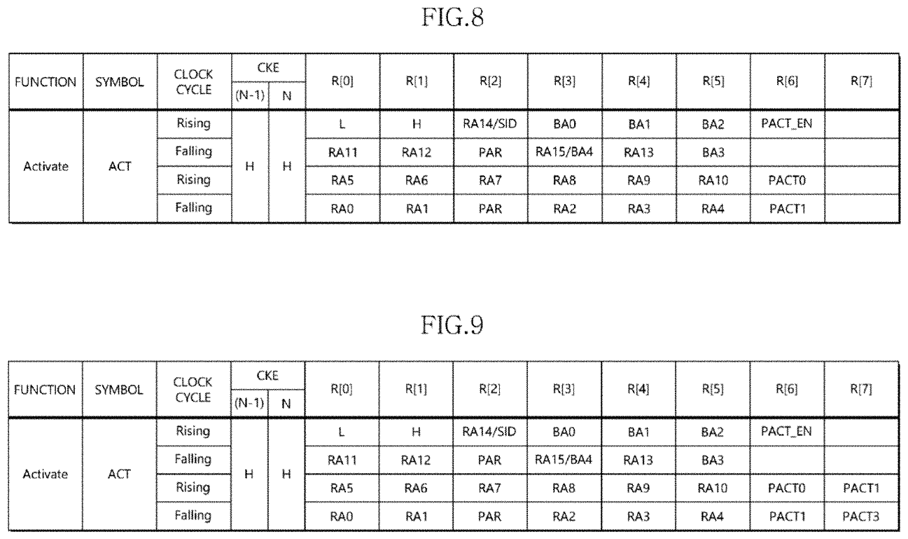

FIG. 8 and FIG. 9 are diagrams for explaining mode setting processes in accordance with embodiments, and show signals in an active command (ACT) according to embodiments.

Referring to FIG. 8 and FIG. 9, a partial page activation mode enable signal PACT_ EN for partially activating a page to be accessed and the positions PACT0 to PACT3 of sub-pages to be activated may be transmitted through the interface signal R[6] (and in FIG. 9, interface signal R[7] as well).

FIG. 8 illustrates a case where the partial page activation mode enable signal PACT_EN is transmitted using the interface signal R[6] on the rising edge of the first cycle of transmitting the active command ACT and the 2-bit activation mode control signals PACT0 and PACT1 are transmitted through the interface signal R[6] on the rising and falling edges of the second cycle. Each page may be divided into four sub-pages using the 2-bit activation mode control signals PACT and may be partially activated on a sub-page basis.

FIG. 9 illustrates a case where the partial page activation mode enable signal PACT_EN is transmitted using the interface signal R[6] on the rising edge of the first cycle of transmitting the active command ACT and the 4-bit activation mode control signals PACT0 to PACT3 are transmitted through the interface signals R[6] and R[7] on the rising and falling edges of the second cycle of transmitting the active command ACT. Each page may be divided into 16 sub-pages using the 4-bit activation mode control signals PACT and may be partially activated on a sub-page basis.

Although not illustrated, the interface signal R[7] may also be additionally used to transmit the activation mode control signals PACT on the rising and falling edges of the first cycle of transmitting the active command ACT, and the interface signal R[6] may also be additionally used to transmit the activation mode control signals PACT on the falling edges of the first cycle of transmitting the active command ACT. Accordingly, the page to be accessed may be divided into 2⁰ to 2⁷ sub-pages and may be partially activated.

Referring back to FIG. 7, when the page to be accessed is partially activated by the activation mode control signals PACT, the memory controller 307 may request the memory apparatus 200 to read data stored in the initial parameter storage address (S213), and the memory apparatus 200 may read the data stored in the corresponding address, that is, the initial parameter and provide the read initial parameter to the accelerator 311 (S215).

The accelerator 311 may load the initial parameter and process the computation (S217). Data may be inputted and outputted to/from the memory apparatus 200 operating in the partial page activation mode throughout the computational processing.

When the computation is completed, the accelerator 311 may provide the computation result to the processor 301 (S219), and the processor 301 may provide the task processing result to the host 10 (S221).

Artificial intelligence is a field of research on methods to mimic human intelligence and has a direct and indirect impact on various fields including computer engineering and semiconductors.

Due to the recent active research result on artificial neural network algorithms and machine learning, the accuracy of image recognition, natural language processing and the like has been improved to the human level and high-precision artificial intelligence technologies are also expected to be implemented in fields of autonomous vehicles, automated systems and the like in the future.

In processing an artificial intelligence algorithm, pages in a memory area repeatedly accessed during the computational process are only partially activated (so that data in the pages that is not needed by the artificial intelligence algorithm is not wastefully accessed), and as a result it is possible to increase the power efficiency of the data processing system 100.

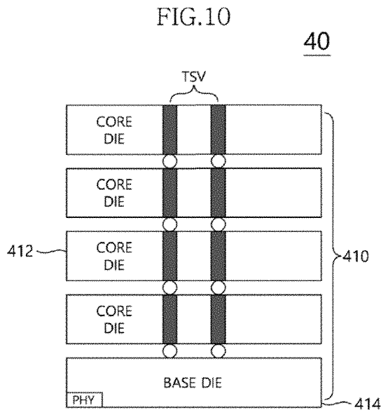

FIGS. 10 to 12 illustrate stacked semiconductor apparatuses in accordance with embodiments.

FIG. 10 illustrates a stacked semiconductor apparatus 40 in accordance with an embodiment.

The stacked semiconductor apparatus 40 may include a stack structure 410 in which a plurality of dies are stacked. The stack structure 410 may be configured in a high bandwidth memory (HBM) type in which the plurality of dies are stacked and electrically connected to one another via through-silicon vias (TSV), so that the number of input/output units is increased and thus a bandwidth is increased.

The stack structure 410 may include a base die 414 and a plurality of core dies 412.

The plurality of core dies 412 may be stacked on the base die 414 and electrically connected to one another via the through-silicon vias (TSV). In each of the core dies 412, memory cells for storing data and circuits for core operations of the memory cells may be disposed.

The core dies 412 may be electrically connected to the base die 414 via the through-silicon vias (TSV) and receive signals, power and the like from the base die 414 via the through-silicon vias (TSV).

The base die 414, for example, may include the controller 300 and the memory apparatus 200 illustrated in FIGS. 1 to 3. The base die 414 may perform various functions in the stacked semiconductor apparatus 40, for example, memory management functions such as power management and refresh of the memory cells or timing adjustment functions between the core dies 412 and the base die 414.

A physical interface area PHY included in the base die 414 may be an input/output area of an address, a command, data, a control signal and the like. The physical interface area PHY may be provided with a predetermined number of input/output circuits capable of satisfying a data processing speed required for the stacked semiconductor apparatus 40. A plurality of input/output terminals and a power supply terminal may be provided in the physical interface area PHY on the rear surface of the base die 414 to receive signals and power required for an input/output operation.

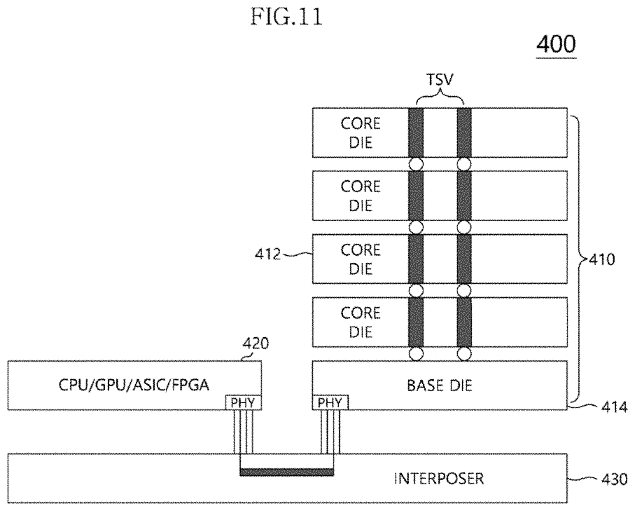

FIG. 11 illustrates a stacked semiconductor apparatus 400 in accordance with an embodiment.

The stacked semiconductor apparatus 400 may include a stack structure 410 of a plurality of core dies 412 and a base die 414, a memory host 420, and an interface substrate 430. The memory host 420 may be a CPU, a GPU, an application specific integrated circuit (ASIC), a field programmable gate arrays (FPGA) and the like.

The base die 414 may be provided with a circuit for an interface between the core dies 412 and the memory host 420. The stack structure 410 may have a structure similar to that described with reference to FIG. 10.

A physical interface area PHY of the stack structure 410 and a physical interface area PHY of the memory host 420 may be electrically connected to each other through the interface substrate 430. The interface substrate 430 may be referred to as an interposer.

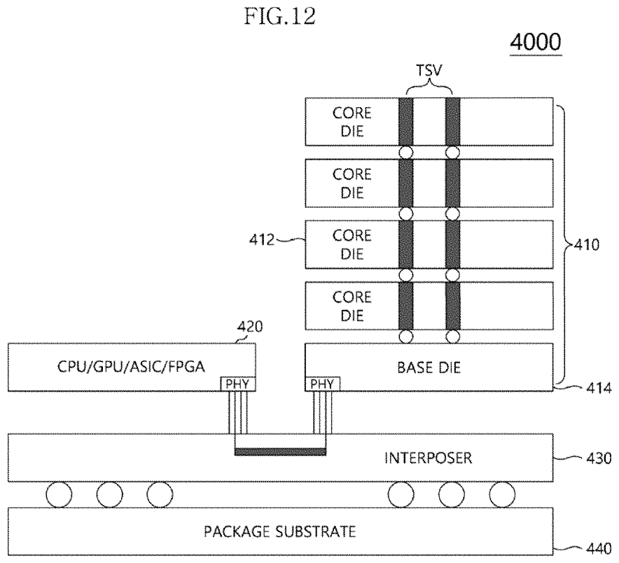

FIG. 12 illustrates a stacked semiconductor apparatus 4000 in accordance with an embodiment.

It may be understood that the stacked semiconductor apparatus 4000 illustrated in FIG. 12 is obtained by disposing the stacked semiconductor apparatus 400 illustrated in FIG. 11 on a package substrate 440.

The package substrate 440 and the interface substrate 430 may be electrically connected to each other through connection terminals.

A system in package (SiP) type semiconductor apparatus may be implemented by staking the stack structure 410 and the memory host 420, which are illustrated in FIG. 11, on the interface substrate 430 and mounting them on the package substrate 440 for the purpose of package.

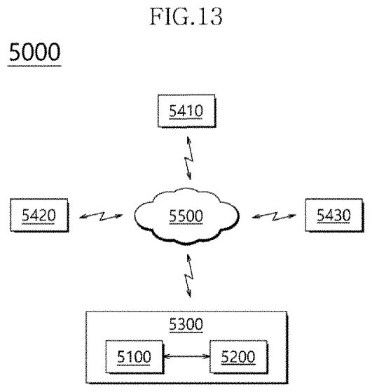

FIG. 13 is a diagram illustrating a network system 5000 including a data storage device, in accordance with an embodiment. Referring to FIG. 13, the network system 5000 may include a server system 5300 and a plurality of client systems 5410, 5420, and 5430, which are coupled through a network 5500.

The server system 5300 may service data in response to requests from the plurality of client systems 5410 to 5430. For example, the server system 5300 may store the data provided by the plurality of client systems 5410 to 5430. For another example, the server system 5300 may provide data to the plurality of client systems 5410 to 5430.

The server system 5300 may include a host device 5100 and a memory system 5200. The memory system 5200 may include one or more of the data processing system 100 shown in FIG. 1, the stacked semiconductor apparatuses 40 shown in FIG. 10, the stacked semiconductor apparatus 400 shown in FIG. 11, or the stacked semiconductor apparatus 4000 shown in FIG. 12, or combinations thereof.

While various embodiments have been described above, it will be understood to those skilled in the art that the embodiments described are examples only. Accordingly, the data processing system and the operating method thereof described herein should not be limited based on the described embodiments.

What is claimed is:

1. A data processing system comprising:
a memory apparatus including a plurality of pages and accessible in units of the pages; and
a controller configured to control the memory apparatus,
wherein the controller comprises:
a mode control component configured to generate an activation mode control signal for setting the memory apparatus in a partial page activation mode based on a type of a processing task requested by a host and address information requested to be accessed, and
wherein less than all of a page of the memory apparatus being accessed is activated when the memory apparatus is in the partial page activation mode.

2. The data processing system according to claim 1, wherein each of the plurality of pages includes a plurality of memory cells connected between a word line and a bit line.

3. The data processing system according to claim 1, wherein each of the plurality of pages includes a plurality of sub-pages,
the address information includes information on a sub-page to be accessed, and
the controller is configured to transmit, to the memory apparatus, a partial page activation mode enable signal and information on a sub-page to be activated in response to the activation mode control signal.

4. The data processing system according to claim 3,
wherein the controller is configured to put the partial page activation mode enable signal into a mode setting command and transmit the mode setting command to the memory apparatus, and
wherein the memory apparatus is configured to set a mode register set (MRS) according to the partial page activation mode enable signal.

5. The data processing system according to claim 3, wherein the controller is configured to transmit, to the memory apparatus, the information on the sub-page to be activated by using an operation control signal.

6. The data processing system according to claim 5, wherein the operation control signal includes an active command.

7. The data processing system according to claim 3, wherein the controller is configured to transmit, to the memory apparatus, the partial page activation mode enable signal and the information on the sub-page to be activated by using an operation control signal.

8. The data processing system according to claim 7, wherein the operation control signal includes an active command.

9. A data processing system comprising:
a memory apparatus including a plurality of pages and accessible in units of the pages; and
a controller configured to control the memory apparatus,
wherein the controller comprises:
a mode control component configured to control, in response to a request of a host for processing an application offloaded and requested to be processed by the host and address information requested to be accessed, the memory apparatus to activate only a sub-page of a page of the memory apparatus being accessed; and
an accelerator configured to process the application according to data read from the activated sub-page so as to execute the application and to store a processing result in the activated sub-page.

10. The data processing system according to claim 9, wherein each of the plurality of pages respectively includes a plurality of sub-pages,
the address information includes information on a sub-page to be accessed, and
the controller is configured to transmit, to the memory apparatus, the information on the sub-page to be activated by using an operation control signal.

11. An method of operating a data processing system including a memory apparatus including a plurality of pages and accessible in units of the pages and a controller configured to control the memory apparatus, the method comprising:
transmitting, by the controller and to the memory apparatus, an activation mode control signal for activating a partial page activation mode of the memory apparatus based on a type of a processing task requested by a host and address information requested to be accessed; and
activating, by the memory apparatus, only a sub-page of a page of the memory apparatus being accessed when the memory apparatus is in the partial page activation mode.

12. The method according to claim 11, wherein each of the plurality of pages includes a plurality of sub-pages and the address information includes information on a sub-page to be accessed, and transmitting the activation mode control signal further comprises:
transmitting a partial page activation mode enable signal to the memory apparatus; and
transmitting information on a sub-page to be activated to the memory apparatus.

13. The method according to claim 12,
wherein transmitting the partial page activation mode enable signal further comprises including the partial page activation mode enable signal into a mode setting command and transmitting the mode setting command to the memory apparatus; and
wherein the method further comprises setting, by the memory apparatus, a mode register set (MRS) according to the partial page activation mode enable signal.

14. The method according to claim 12, wherein the partial page activation mode enable signal is transmitted using an operation control signal.

15. The method according to claim 14, wherein the operation control signal includes an active command.

16. The method according to claim 12, wherein the partial page activation mode enable signal and the information on the sub-page to be activated are transmitted using an operation control signal.

17. The method according to claim 16, wherein the operation control signal includes an active command.
